(19) United States
(12) Patent Application Publication
(10) Pub. No.: US 2008/0123580 A1
(43) Pub. Date: May 29, 2008

(54) Transferable Wireless Communicator For Data And Voice

(75) Inventor: Vickram R. Vathulya, San Jose, CA (US)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., Eindhoven (NL)

(21) Appl. No.: 10/561,473

(22) PCT Filed: Jun. 23, 2004
(86) PCT No.: PCT/IB2004/050986

§ 371 Date: Dec. 20, 2005

Related U.S. Application Data
(60) Provisional application No. 60/482,311, filed on Jun. 25, 2003.

(51) Int. Cl. H04B 1/38; H04Q 7/32

(52) U.S. Cl. 370/314; 455/553.1

(57) ABSTRACT

A communicator (110) that is transferable across different types of mobile devices (210) is disclosed. The communicator can simultaneously operate with both voice communication links (190) and data communication links (192), and with both voice and data information. The communicator may be transferred across various mobile devices, including but not limited to: mobile telephones (120), personal digital assistants (130), music players (170), radios, mobile computers (145), or devices that are a combination thereof. Some embodiments of the invention may be transferred while operating without breaking a wireless communication link. Data information may carried on a data link, such as a Bluetooth® link, a wireless Ethernet link, or an IEEE 802.11 link. Data information may also be carried on the voice link, such as a global system for mobile communication (GSM) link or a code division multiple access (CDMA) link. Similarly, voice information may be carried either on the voice link or on the data link, for example, voice over Internet protocol (IP).

The invention relates generally to methods and apparatuses for mobile and wireless communication of voice and data. More particularly, the invention relates to a wireless communicator adapted for a variety of host devices including mobile telephones, mobile computers, personal digital assistants, music players and other host devices.

Modern society and technology are increasingly based on mobility, and on communicating with individuals while they are away from the home or the office in which they are based. Mobile and wireless communication systems for voice, data or both involve rapidly changing technology and have spurred on a rapid growth in industrial activity.

One problem arising in mobile and wireless communication systems is the limited range of areas in which a user can be while accessing communication services. The signal strength of wireless communication links may vary substantially in a manner that a typical user is not aware of and cannot predict. Thus, users may spend considerable time and effort attempting to find out where his communication device does work.

A related problem is the quality of the wireless services that are received. Poor quality communication, interrupted or dropped communication sessions and the like may impose substantial inconvenience on users. A signal may be present, but too weak for effortless conversation. It makes quite a difference in convenience to the user, for example, if he can spell out the word “cat” as “C,” “A,” “T” rather than as “Charlie,” “Alpha,” “Tango.” Having to constantly repeat thing that are said, or to confuim that they were heard correctly is also inconvenient, time consuming, and potentially confusing.

Another problem arising in mobile and wireless communication systems is cost. Wireless communication typically involves high costs—both one time costs for the manufacture or purchase of wireless devices, and recurring costs for the services that provide the communication to the devices. It is not uncommon for a businessman who travels with some regularity to have a mobile telephone, a mobile computer with wireless access, and a personal digital assistant (PDA) with wireless access. Such duplication of wireless access circuitry is unnecessary and unnecessarily costly.

In addition to purchasing and manufacturing costs, service costs, such as usage fees per minute or per message, often become much larger than the equipment cost. Pricing structures and plans for wireless communication are often complicated, may involve both a home-base service provider and a different current-location or roaming service provider, and may have loopholes or exceptions that when triggered unexpectedly escalate the costs. It may take longer for a user to verify what charges would apply in a particular situation so as to select the optimal communication path or the optimal location from which to communicate than for the user to perform the communication.

Another problem arising in mobile and wireless communication systems is security. It can be risky to allow access to sensitive data from locations that are not under the physical control of the owner of the data. Mechanisms are required to authenticate that the user is authorized to have access to the data. Mechanisms are also required to encrypt the data so that it is not available via casual eavesdropping or via sophisticated interception.

Even when no confidential information is involved, such as simply initiating a call to a public phone number, it should be verified that the user has a currently valid account to charge for the communication services that the call or communication session uses. Unfortunately, authentication, security and verification mechanisms are rarely transparent to the user; rather, they may impose substantial inconvenience on the user.

Current approaches to these problems generally impose substantial burdens on the user: burdens of inconvenience, burdens of the user needing to know a lot about how his mobile communication devices operate, and burdens of the user spending time concerned with the technical details of the communication session and equipment, rather than the information content of the communication.

The object of the invention is to provide an improved wireless communicator. Some embodiments of the invention advantageously provide: increased user convenience; a larger area in which communication services are available; reduced one-time costs for manufacturing or purchasing mobile devices; reduced recurring subscription costs for mobile communication services; better quality of mobile communications; better security to prevent the unauthorized access to information or services; or better security to prevent the interception of mobile communication.

The invention provides a wireless communicator that is transferable across mobile host devices of two or more types. Suitable mobile most devices include, but are not limited to: mobile telephones, personal digital assistants, music players, radios, or mobile computers.

The wireless communicator includes a voice receiver, a data receiver, a voice transmitter, a data transmitter, and a baseband modem. The communicator receives an outgoing host signal from an active one of the mobile host devices and provides an incoming host signal to the active host.

In some embodiments of the invention, the baseband modem operates in various modes, for example, a mode that converts the incoming voice baseband signal to the incoming host signal, or a mode that converts the outgoing host signal to the outgoing voice baseband signal.

Some embodiments of the invention include a controller that controls the mode of the baseband modem, or that initiates communication links between the wireless communicator and an external device. As part of initiating such links, the controller may determine which communication links are currently available, or may select a preferred one of the available links. Further, the controller may keep the communication link active while the wireless communicator is transferred from a first mobile host device being active to a different mobile host device being active. Further, the controller may use data from a nonvolatile memory in initiating communication links. Such data may include subscription data, user identification data, user preference data, security data, or other data.

Objects, features and advantages of the invention will become apparent from the descriptions and discussions herein, when read in conjunction with the drawings. Technologies related to the invention, example embodiments of the invention, and example uses of the invention are illustrated in the various drawings, which are as follows:

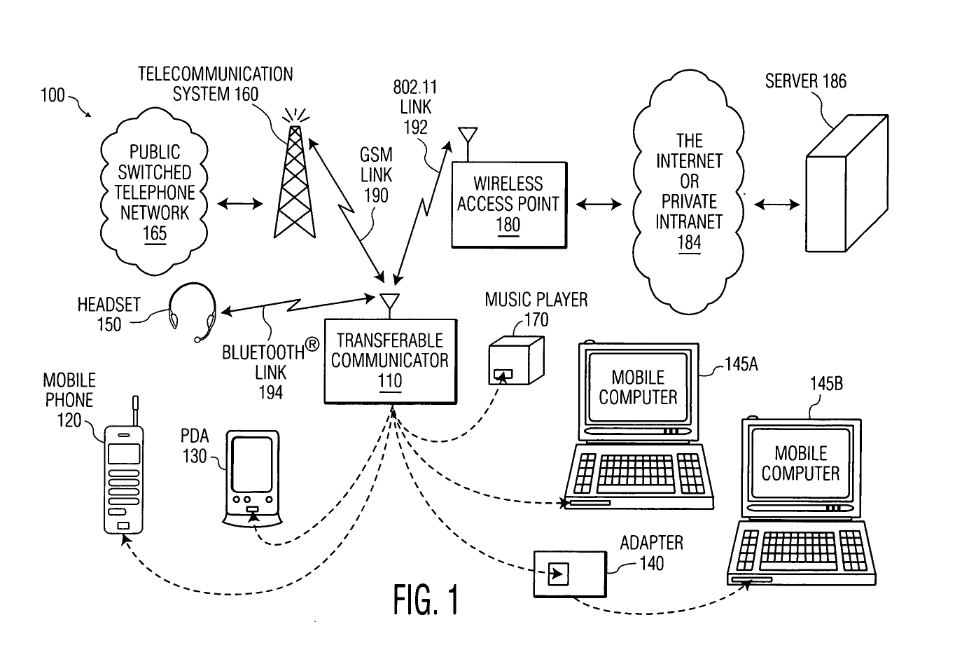

FIG. 1 shows the functional components and their interconnections in a wireless communication system, according to an embodiment of the invention, that connects a variety of mobile devices to the telephone network, to a data server, or to both, via a communicator that can be transferred among the mobile devices.

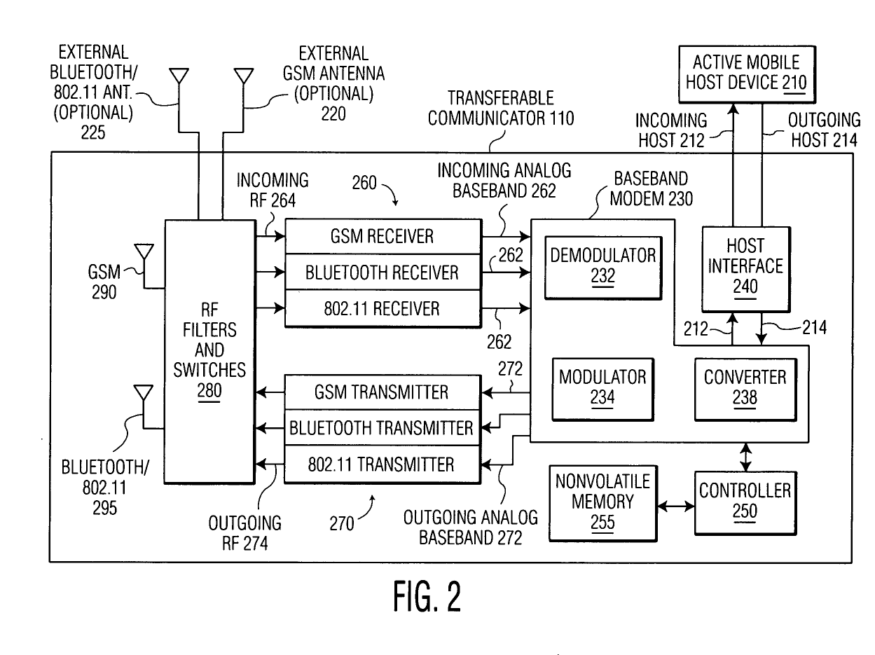

FIG. 2 shows the functional components and their interconnections in a transferable communicator according to an embodiment of the invention.

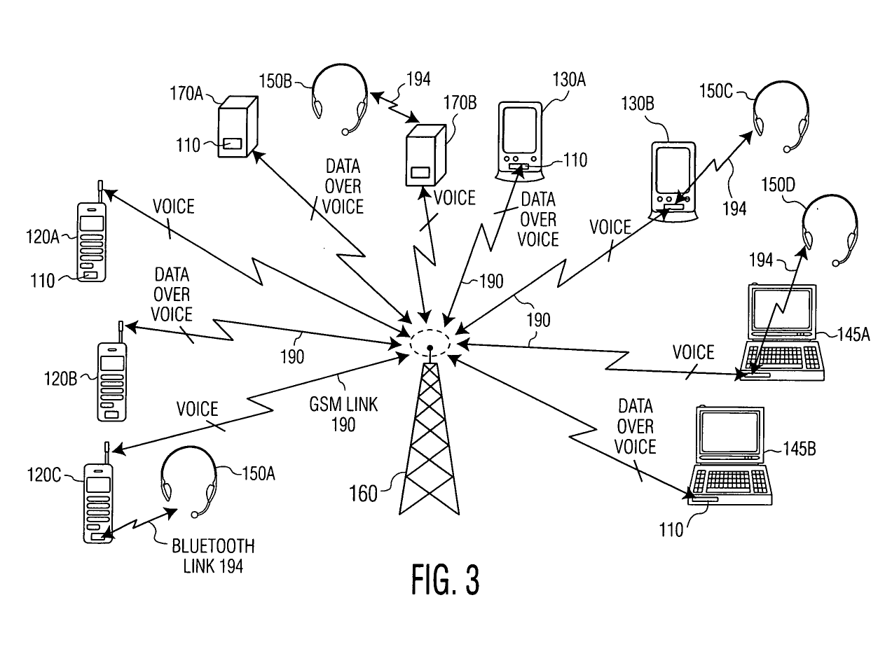

FIG. 3 illustrates a number of modes in which a transferable communicator, according to an embodiment of the invention, can communicate over a radio link designed for voice communication.

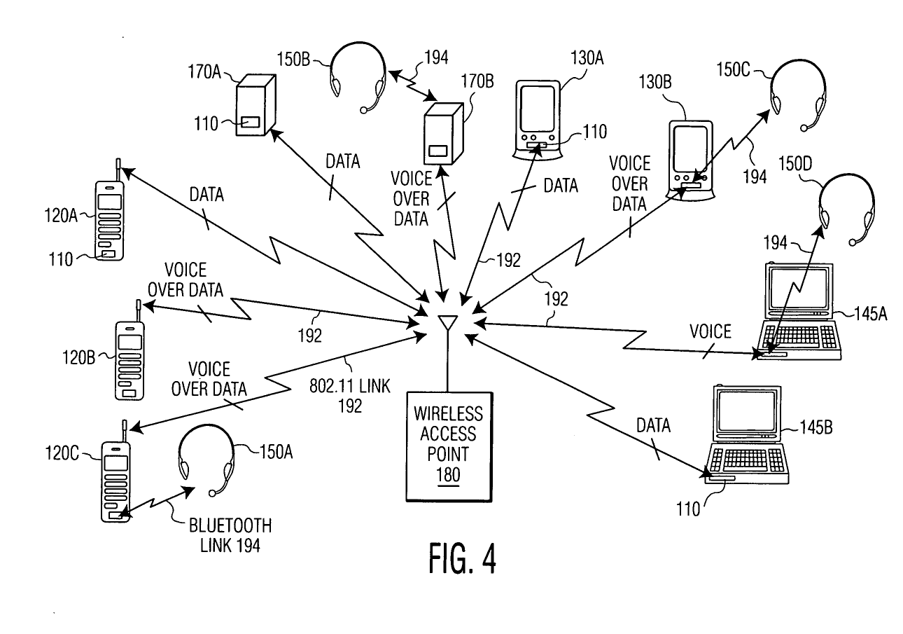

FIG. 4 illustrates a number of additional modes in which a transferable communicator, according to an embodiment of the invention, can communicate over a radio link designed for data communication.

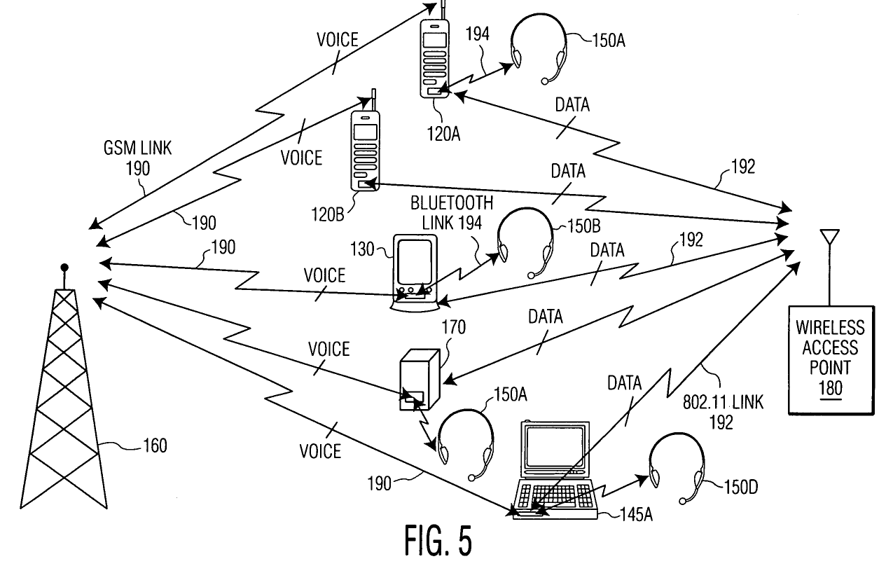

FIG. 5 illustrates yet another mode in which a transferable communicator, according to an embodiment of the invention, can communicate by simultaneously using a data radio link and a voice radio link.

The descriptions, discussions and figures herein illustrate technologies related to the invention, show examples of the invention and give examples of using the invention. Known methods, procedures, systems, circuits, or elements may be illustrated and described without giving details so as to avoid obscuring the principles of the invention. On the other hand, details of specific embodiments of the invention are presented, even though such details may not apply to other embodiments of the invention.

Some descriptions and discussions herein use abstract or general terms including but not limited to, equal, assert, “true” or “false”. Those skilled in the art use such terms as a convenient nomenclature for components, data or operations within a computer, digital or electromechanical system. Such components, data and operations are represented by physical properties of actual objects including but not limited to electronic voltage, magnetic field and optical reflectivity. For example, “asserted” or “true” may refer to an electronic signal that is around 3 volts and “not asserted” or “false” may refer to a signal around 0.3 volts, or vice versa. Similarly, perceptive or mental terms including but not limited to determine, initiate, select and control may also refer to such components, data, operations or manipulations of physical properties.

FIG. 1 is a functional block diagram of a wireless communication system according to an embodiment of the invention. System 100 connects a variety of mobile devices to the public switched telephone network (PSTN) 165, to data server 186, or to both. Each of these connections or wireless communication links occur via a communicator that can be transferred across the mobile devices.

Transferable communicator 110 is physically and electronically adapted to be connected with, and to operate with, any one of a number of mobile host devices. These mobile host devices include devices of various types, including: mobile telephone 120, personal digital assistant (PDA) 130, mobile computers 145, music player 170, a device that combines the functions of two or more such devices, or any mobile electronic device capable of sending or receiving voice or data from another electronic device.

Transferable communicator 110 establishes and maintains a wireless, radio communication link with one or more of headset 150, telecommunication system 160, or wireless access point 180. Headset 150 provides sounds to the user. Telecommunication system 160 provides communication between the public switched telephone network (PSTN) and the active host, that is the particular mobile host device to which communicator 110 is attached and with which communicator 110 is operating. Wireless access point 180 provides communication with server 186 via network 184.

Global system for mobile communication (GSM) link 190 is a wireless, voice-oriented, radio link between transferable communicator 110 and telecommunication system 160. Bluetooth® link 194 is wireless radio link between communicator 110 and headset 150. The 802.11 communication link 192 is a wireless, data-oriented, radio link between communicator 110 and wireless access point 180. Information on the Bluetooth standard has been published at www.bluetooth.org. Information on the IEEE 802.11 standard has been published at www.ieee.org.

Network 184 couples wireless access point 180 with server 186. Wireless access point 180 couples the active host device to server 184. In turn, server 186 performs requests from and provides information to the mobile device attached to transferable communicator 110.

In various embodiments of the invention, GSM link 190 may be replaced by, or supplemented with one or more voice-oriented communication links, including: a mobile telephone link, a cellular telephone link, an Advanced Mobile Phone System (AMPS) link, a time division multiple access (TDMA) link, code division multiple access (CDMA) link, a CDMA-2000 link, a wideband code division multiple access (WCDMA) link, or any voice-oriented wireless communication mechanism between communicator 110 and system 160.

In various embodiments of the invention, 802.11 link 192 may be replaced by, or supplemented with one or more voice-oriented communication links, including: a wireless local area network (WLAN) link, a wireless Ethernet link, a link according to a version of the Institute of Electrical and Electronics Engineers (IEEE) standard 802.11, or any data-oriented wireless communication mechanism between communicator 110 and wireless access point 180.

In various embodiments of the invention, Bluetooth link 194 may be replaced by, or supplemented with one or more low-power communication links.

Network 184 may be the Internet, a private intranet, a local area network (LAN), a wide area network (WAN), or a combination of two or more such networks. Server 186 may be a computer, a web server, or any device capable of communicating to the mobile host device data that is of interest to the user.

Music player 170 may be a Moving Picture Experts Group (MPEG) Layer-3 Audio (MP3) player, an frequency modulation (FM) radio, an amplitude modulation (AM) radio, a combination of two or more of such devices, or any device that provides audio to the user.

Each mobile host device includes a plug, receptacle, socket, or the like that directly receives, holds, or physically couples to communicator 110, or includes an indirect coupling. For example, communicator 110 can be connected with mobile computer 145B via adaptor 140.

Adapter 140 includes a socket that receives transferable communicator 110. The adapter is in turn received by mobile computer 145B. The mechanical and electronic interface between adapter 140 and computer 145B may follow a version of the Personal Computer Memory Card International Association (PCMCIA) standard. In contrast, mobile computer 145A includes a socket that directly couples to communicator 110.

The headset includes earphones for listening to a voice conversation, music, recorded audio, or other audio signals. The headset may also include a microphone to support electronically capturing and transmitting or recording the user's voice.

FIG. 2 is a functional block diagram of a transferable communicator according to an embodiment of the invention. FIG. 2 also shows the interconnections between transferable communicator 110 and active host 210, as well as the interconnections between transferable communicator 110 and optional external antenna or antennas 220.

Transferable communicator 110 includes baseband modem 230, host interface 240, controller 250, nonvolatile memory 255, receiver 260, transmitter 270, radio frequency (RF) filter and switch assembly 280, internal GSM antenna 290 and internal Bluetooth/Ethernet antenna 295. Baseband modem 230 includes demodulator 232, modulator 234 and converter 238. Each of receiver 260 and transmitter 270 have sections for GSM voice signals, 802.11 data signals, and Bluetooth low-power signals.

GSM link 190 includes incoming radio signals and outgoing radio signals, both of which are designed for voice communication. The incoming radio signals are converted into an incoming RF electrical signal 264 by either internal GSM/CDMA antenna 290, one of external antennas 220, or both. The outgoing radio signals are generated from radio frequency (RF) electrical signals 274 supplied to the same antenna(s).

Communication links 192 or 194 each include incoming radio signals and outgoing radio signals. The incoming radio signals are converted into incoming RF electrical signals 264 by either internal Bluetooth/802.11 antenna 295, one of external antennas 220, or both. The outgoing radio signals are generated from outgoing RF electrical signals 274 supplied to the same antenna(s). It is expected that satisfactory performance can be achieved by sharing one antenna between Bluetooth and 802.11 signals, however some embodiments of the invention use separate antennas for each type of signal.

The incoming and outgoing RF electrical signals 264 and 274 are, respectively, received by and provided by the appropriate sections within receiver 260 and transmitter 270. Various embodiments of the invention contain two or more receiver and transmitter sections of various designs.

RF filter and multiplexer assembly 280 couples the incoming radio signals between the antenna(s) and receiver 260, and the outgoing radio signals between the antenna(s) and transmitter 270. An important function of assembly 280 is to attenuate the amount of energy from the transmitted radio signals that is coupled back into receiver 260.

Receiver 260 generates incoming baseband analog signals 262 from incoming RF electrical signals 264. Incoming baseband analog signals 262 are coupled to demodulator 232 within baseband modem 230, which generally converts these signals to digital data, though the signals may remain analog in some embodiments of the invention.

Transmitter 270 generates outgoing RF electrical signals 274 from outgoing baseband analog signals 274. Outgoing baseband analog signals 272 are generated by modulator 234 within baseband modem 230, which generally converts these signals from digital data, though the outgoing signals may already be analog in some embodiments of the invention.

Host interface 240 electronically couples transferable communicator 110 with active host device 210. In particular, the host interface conveys one or more incoming host signals 212 from baseband modem 230 to the host, one or more outgoing host signals 214 from the host to the baseband modem, and power from the host to the various components within the communicator. Optionally, host interface 240 also couples one or more external antennas 220 or 225 to RF filters and switches 280. Optionally, host interface 240 also couples one or more control signals between transferable communicator 110 and active host device 210, including but not limited to a wake up signal, or a shut down signal.

In various modes of operation, baseband modem 230 provides modulator 234 with one or more signals from demodulator 232 that are derived from the incoming analog baseband signals 262 that come from various sections within receiver 260. In other modes, the baseband modem provides the modulator with outgoing host signal 214 that comes from active host 210. In yet other modes, multiple signals are provided to the modulator, from which the modulator generates multiple outgoing analog baseband signals 272, each corresponding to a section within transmitter 270. In these modes, some of the signals provided to the modulator may come from the mobile device, and others may come from the demodulator.

Baseband modem 230 also operates in various modes with respect to incoming host signal 212 provided to mobile host 210. Baseband modem 230 provides mobile device 210 with one or more incoming signals from demodulator 232 based on the appropriate section(s) within receiver 260 based on the current mode of operation of baseband modem 230.

Each of these modes involve selection of appropriate data transfer paths within baseband modem 230. Some of them may involve format conversions, which are performed by converter 238.

The selection of data paths within baseband modem 230 and the selection of the conversion functions, if any, performed by converter 238 may be controlled by controller 250. Controller 250 may enable and disable the paths and conversion operations as appropriate to the mode in which the transferable communicator is currently operating. Alternatively or additionally, mobile device 210 may control the communication paths through baseband modem 230, or may control or perform the formatting and conversion operations, or both.

In some embodiments of the invention, transferable communicator 110 may maintain one or more of communication links 190, 192 or 194 as active when the communicator is transferred from one active host 210 to another. This feature is advantageous, for example, when a user making a voice call using the communicator learns that there is a file available to be downloaded to his PDA or computer. It is also advantageous when a user reads a message on his PDA or computer that motivates him to place a voice call.

The user may be able to specify which links, if any, are to be kept active, possibly by establishing a setting that applies every time the communicator is transferred. Alternatively or additionally, the user may enter a “maintain link” command prior to physically ejecting the communicator, or may select from a menu displayed on the active host, where the menu includes options labeled “End calls and eject communicator” and “Eject communicator and maintain active calls.”

In order to maintain a communication link as active, controller 250, baseband modem 230, receiver 260 and transmitter 270 remain active while communicator 110 is being transferred. Thus, embodiments of the invention that support this feature must also include a temporary power source able to provide these circuits with enough power to operate in a limited manner for a limited amount of time. This power source may include, among other possibilities: a small battery; or a capacitor and a charge pump to recharge the capacitor when the communicator is reconnected to an active host.

To maintain an active communication link, baseband modem 230, controller 250 or both detect and respond to any message preambles that are received on any link that is to be maintained. The response is preferably, but not necessarily, limited to instructing the device on the other end of the link to maintain the link as active. Power consumption from the temporary power source is reduced by not sending or receiving any voice or data during the period when the communicator is being transferred.

Nonvolatile memory 255 holds subscriber information, security information, other information, or a combination of such information. Controller 250 accesses this information and provides it to baseband modulator 230, to mobile device 210, or to both as appropriate.

Baseband modem 230 is known in the art. For example, Nokia Inc. of Irving, Tex. and Tokyo, Japan has published information about their baseband modem products at www.nokia.com. Similarly, Qualcomm, Inc. of San Diego, Calif. has published information about their baseband modem products at www.qualcomm.com. Any circuit or device capable of appropriately modulating, demodulating, routing and converting incoming analog baseband signals 262, incoming host signal 212, outgoing analog baseband signals 272, and outgoing host signal 214 may be used as baseband modem 230.

Receiver 260 is known in the art. Any device capable of appropriately converting RF electrical signals into baseband analog signals may be used. Transmitter 270 is well known in the art. Any device capable of appropriately converting baseband analog signals into RF electrical signals may be used.

Antennas 220, 290 and 295 are known in the art. The internal antennas may be patch antennas, and the external antennas may be monopoles. Any device capable of converting electrical signals to radio signals, and vice versa, may be used for these devices. RF filter and switch assembly 280 is well known in the art. Any device capable of appropriately coupling and decoupling RF electrical signals may be used.

In various embodiment of the invention, controller 250 may be a simple state machine, a processor operating under control of programmed instructions, or a combination thereof. Any circuit or device capable of receiving from the user an indication of the mode of operation that is currently desired, controllingbaseband modem 230 appropriately, and initiating and maintaining the appropriate communication links may be used as controller 250.

Nonvolatile memory 250 is known in the art. Any device capable of holding data may be used, including but not limited to flash memory, or electrically erasable programmable read only memory (EEPROM).

In various embodiments of the invention, nonvolatile memory 255 holds various subscriber information including: the telephone number at which the mobile device attached to the transferable communicator can be reached, the account number of the user with one or more service providers, or other information.

In various embodiments of the invention, nonvolatile memory 255 holds various security information including: the password that the user must enter before the transferable communicator will operate, passwords that the mobile device must provide to log into various sessions or services, public keys of the individuals, organizations or servers with whom the mobile device is likely to have communication links, and a private key or keys of the user.

FIG. 3 illustrates a number of modes in which a transferable communicator, according to an embodiment of the invention, can support voice communication, data communication, or both using only a voice-oriented link.

Mobile telephone 120A includes a transferable communicator 110 that operates in a mode in which voice is carried over GSM communication link 190 between telecommunication system 160 and telephone 120A. While this mode is active, the user is having a real-time conversation. In this conversation, the user probably perceives little or no change from the functionality and quality of service provided by mobile telephone according to the background art.

Mobile telephone 120C includes a transferable communicator 110 that operates in a mode in which voice is carried both over GSM communication link 190 and over Bluetooth communication link 194 between telecommunication system 160 and headset 150A. In this mode, the user talks and listens via a wireless headset, and need not keep the telephone next to his ear and mouth.

Mobile telephone 120B includes a transferable communicator 110 that operates in a mode in which data is carried over voice-oriented GSM communication link 190 between telecommunication system 160 and headset 150A. Such data may include, but is not limited to, web pages, maps or driving directions, text messages, alphanumeric pages, stock quotes or alerts, weather information or forecasts, traffic information, or combinations of such information. Such data transfers may, but need not, use the wireless access protocol (WAP).

When a mobile telephone is the active host, transferable communicator 110 may operate in additional modes of operation that are not shown in FIG. 3. For example, voice and data information could be carried simultaneously over the same GSM link to and from the telephone. Or, voice and data could be simultaneously carried over the GSM link, with the transferable communicator transferring the data information to and from the telephone, and relaying the voice information to and from a headset.

Music player 170A includes a transferable communicator 110 that operates in a data over voice mode in which data information is carried over GSM link 190 between telecommunication system 160 and music player 170A. The data information being carried may include a voice mail message being forwarded for storage and later playback on the music player, a song being downloaded to the music player, or other audio information.

Music player 170B includes a transferable communicator 110 that operates in a mode in which voice is carried over both GSM link 190 and Bluetooth link 194. The voice information is relayed by the communicator to and from headset 150B. The user is having a real-time conversation using the headset. The music player may be involved in the conversation only indirectly as a source of power for the communicator. Alternatively, transferable communicator 110 may provide the voice information to music player 170B to be recorded and held.

When a music player is the active host, transferable communicator 110 may operate in an additional mode that is not shown in FIG. 3. That is, voice and data information can be carried simultaneously over the same GSM link to and from the communicator. The communicator can provide the data information to the music player and can relay the voice information to and from a headset.

PDA 130A includes a transferable communicator 110 that operates in a mode in which data is carried over voice-oriented GSM link 190 between telecommunication system 160 and PDA 130A. The content and format of such data may be as described above with respect to mobile telephone 120A, or PDA-oriented content and format may be used.

PDA 130B includes a transferable communicator 110 that operates in a mode in which the communicator relays voice information that is carried both over GSM link 190 and over Bluetooth link 194, on the path from telecommunication system 160 to headset 150C. Again, the user is having a real-time conversation and the PDA may be involved only indirectly as a source of power for the transferable communicator.

When a PDA is the active host, transferable communicator 110 may operate in an additional mode that is not shown in FIG. 3. That is, voice and data information can be carried simultaneously over the same GSM link to and from the communicator. The transferable communicator can relays the data information to and from the PDA, and can relay the voice information to and from the headset.

Mobile computer 145B includes a transferable communicator 110 that operates in a mode in which data is carried over voice-oriented GSM communication link 190 between telecommunication system 160 and mobile computer 145B. The content and format of such data may be as described above with respect to mobile telephone 120A or PDA 130A, or it may be equivalent to a computer using a dial up network connection over a voice-oriented communication link.

Mobile computer 145A includes a transferable communicator 110 that operates in a mode in which the communicator relays voice information to and from GSM link 190 and Bluetooth link 194. In this mode, the communicator completes the communication path from telecommunication system 160 to headset 150D, thus allowing the user to have a real-time conversation.

When a mobile computer is the active host, transferable communicator 110 may operate in an additional mode that is not shown in FIG. 3. That is, voice and data information can be carried simultaneously over the same GSM link to and from the communicator. The transferable communicator can relay the data information to and from the mobile computer and can relay the voice information to and from the headset.

FIG. 4 illustrates a number of operational modes, distinct from those of FIG. 3, in which a transferable communicator, according to an embodiment of the invention, can support voice communication, data communication, or both using only a data-oriented link.

Mobile telephone 120A includes a transferable communicator 110 that operates in a mode in which data is carried over 802.11 communication link 192 between wireless access point 160 and telephone 120A. Such data may include, but is not limited to, web pages, maps or driving directions, text messages, alphanumeric pages, stock quotes or alerts, weather information or forecasts, traffic information, or combinations of such information.

Mobile telephone 120B includes a transferable communicator 110 that operates in a mode in which voice is carried over data-oriented 802.11 communication link 192 between wireless access point 160 and telephone 120B. While this mode is active, the user is having a real-time conversation. The user may perceives some change in the quality of service provided in this mode, because the quality of voice over data services is limited, particularly where relatively low speed communication links or relatively heavily loaded communication data networks are used.

Mobile telephone 120C includes a transferable communicator 110 that operates in a mode in which voice is carried over both data-oriented 802.11 communication link 192 and Bluetooth communication link 194 between wireless access point 160 and headset 150A. In this mode, the user participates in his conversation via a wireless headset, and need not keep telephone 120C next to his head.

When a mobile telephone is the active host, transferable communicator 110 may operate in additional modes of operation that are not shown in FIG. 4. For example, voice and data information could be carried simultaneously over the same 802.11 link to and from the telephone. Or, voice and data could be simultaneously carried over the 802.11 link, with the transferable communicator transferring the data information to and from the telephone, and relaying the voice information to and from a headset.

Music player 170A includes a transferable communicator 110 that operates in a mode in which data information is carried over 802.11 link 192 between wireless access point 160 and music player 170A. The data information being carried may include a voice mail message being forwarded for storage and later playback on music player 170A, a song being downloaded to the music player, or other audio information.

Music player 170B includes a transferable communicator 110 that operates in a mode in which voice is carried over data-oriented 802.11 link 192 and relayed by the communicator to and from headset 150B via Bluetooth link 194. The user is having a real-time conversation using the headset. The music player may be involved in the communication session only indirectly as a source of power for communicator 110. Alternatively, communicator 110 may provide the voice information to music player 170B to be recorded and held.

When a music player is the active host, transferable communicator 110 may operate in an additional mode that is not shown in FIG. 4. That is, both voice and data information could be carried simultaneously over the same 802.11 link to and from the communicator.

PDA 130A includes a transferable communicator 110 that operates in a mode in which data is carried over 802.11 link 192 between wireless access point 160 and PDA 130A.

PDA 130B includes a transferable communicator 110 that operates in a mode in which the communicator relays voice information that is carried both over 802.11 link 192 and over Bluetooth link 194, with the voice traveling from wireless access point 180 to headset 150C. The user is having a real-time conversation. PDA 130B may be involved only indirectly as a source of power for the transferable communicator.

When a PDA is the active host, transferable communicator 110 may operate in an additional mode that is not shown in FIG. 4. That is, voice and data information can be carried simultaneously over the same 802.11 link to and from the communicator. The transferable communicator relays the data information to and from the PDA, and relays the voice information to and from the headset.

Mobile computer 145B includes a transferable communicator 110 that operates in a mode in which data is carried over 802.11 communication link 192 between wireless access point 160 and mobile computer 145B. The content and format of such data may be as described above with respect to mobile telephone 120A, or with respect to PDA 130A, or it may be equivalent to a computer using a dial up network connection over a voice-oriented communication link.

Mobile computer 145A includes a transferable communicator 110 that operates in a mode in which the communicator relays voice information to and from 802.11 link 192 and Bluetooth link 194. In this mode, the communicator completes the communication path from telecommunication system 160 to headset 150D, thus allowing the user to have a real-time conversation.

When a mobile computer is the active host, transferable communicator 110 may operate in an additional mode that is not shown in FIG. 3. That is, voice and data information could be carried simultaneously over the same 802.11 link to and from the communicator. The transferable communicator relays the data information to and from the mobile computer, and relays the voice information to and from the headset.

FIG. 5 illustrates yet other modes in which a transferable communicator, according to an embodiment of the invention, can support voice communication, data communication, or both while simultaneously using a data link and a voice link.

Mobile telephone 120B includes a transferable communicator 110 that operates in a mode in which two communication channels are simultaneously active. In one channel, voice is carried over voice-oriented GSM communication link 190 between telecommunication system 160 and telephone 120B. In another channel, data is carried over data-oriented 802.11 communication link 192 between wireless access point 180 and telephone 120B. Such data may include, but is not limited to, web pages, maps or driving directions, text messages, alphanumeric pages, stock quotes or alerts, weather information or forecasts, traffic information, or combinations of such information.

Mobile telephone 120A includes a transferable communicator 110 that operates in a mode in which two communications sessions are simultaneously active over three communication links. The first voice communication session is carried over voice-oriented GSM communication link 190 between telecommunication system 160 and the communicator. As part of this communication session, the communicator relays the voice information to and from headset 150A over Bluetooth link 194. In addition, data is carried in a second communication session over data-oriented 802.11 communication link 192 between wireless access point 180 and telephone 120B.

PDA 130 includes a transferable communicator 110 that operates in a mode in which two communication sessions are simultaneously active over three communication links. Voice is carried over voice-oriented GSM communication link 190 between telecommunication system 160 and the communicator, which relays the voice information to and from headset 150B. Data is carried over data-oriented 802.11 communication link 192 between wireless access point 180 and PDA 130.

Music player 170 includes a transferable communicator 110 that operates in a mode in which two communication sessions are simultaneously active over three communication links. Voice is carried over voice-oriented GSM communication link 190 between telecommunication system 160 and the communicator, which relays the voice information to and from headset 150C. Data is carried over data-oriented 802.11 communication link 192 between wireless access point 180 and music player 170.

Mobile computer 145 includes a transferable communicator 110 that operates in a mode in which two communication sessions are simultaneously active. Voice is carried over voice-oriented GSM communication link 190 between telecommunication system 160 and the communicator, which relays the voice information to and from headset 150D. Data is carried over data-oriented 802.11 communication link 192 between wireless access point 180 and mobile computer 145.

The number of modes in which a transferable communicator, according to various embodiments of the invention, can operate advantageously supports the user in a very flexible manner under a wide range of operating conditions. Advantages achieved by various embodiments of the invention include the following:
Increased user convenience;
A larger area in which communication services are available;
Reduced one-time costs for manufacturing or purchasing mobile devices;
Reduced recurring costs for subscriptions for communication services for mobile devices;
Better quality of communications with mobile devices; and
Better security to prevent unauthorized access to information or services or interception of communication.

User convenience is substantially increased in some embodiments of the invention. The transferable communicator can automatically detect what wireless links and services are available at the current time and in the current location. This can occur by the controller periodically polling to see what is available, or by the controller checking what services are available when the user requests that the host device perform an action.

Automatic detection of available links saves the user from a potentially complex series of attempts or tests to manually determine which services are available. For example, a user who has a mobile telephone and a mobile computer with WLAN capability but does not have a transferable communicator, may need to turn on both his phone and his computer in order to determine what links are available.

The transferable communicator can support simultaneous voice and data communication, regardless of whether a link designed for voice is the only available link, or a link designed for data is the only available link. This can occur by the converter within the baseband modern automatically converting voice information into a structure or format that is suitable for conveyance over data communication links, or vice versa, converting data information into a suitable format for voice links.

The user need not even be aware of the type of communication link that is currently being used to support his activities. Automatic portability of communication and services across links saves the user from a potentially complex series of attempts or tests to manually determine what links are available.

The transferable communicator can allow a user to select which of his mobile devices to use based on what is convenient to him at the time, not based on what communication link is available at the time. In contrast, a user who does not have a transferable communicator, may need to use the device whose communication link is currently available in addition to or instead of the device that is most suitable for the kind of communication he desires. For example, he may have to turn on and boot his computer to make a telephone call using voice over data, or he may have to turn on his mobile telephone and couple it to his computer to access e-mail or download data.

With a transferable communicator, a user only needs to enter one password (the same password) to get access to any service via any of his mobile devices. In contrast, a user who does not have a transferable communicator may need to remember a different account number and password for each type of service he has access to. Or such a user may need to remember a different account number for each mobile device he uses, or perhaps even a number of different accounts and passwords for each type of service on each device.

With a transferable communicator, a user needs to remember only a small amount of security information. A substantial amount of security information can be stored in the nonvolatile memory, where the information is available for use on every one of the user's mobile devices.

Further, the user can authenticate himself to the transferable communicator, such as by entering a password, and then the communicator can authenticate the user to the various communication links and services that the user accesses. In contrast, a user who does not have a transferable communicator may need to reenter account and password information each time he switches between communication links or services.

With a transferable communicator, new account information, new user information (such as the user's preferences), and new security information can be added, by updating the contents of the nonvolatile memory in the transferable communicator, rather than updating information in each of the user's mobile devices. A similar simplification applies to when the current information needs to be updated or renewed.

With a transferable communicator, multiple users can share the same transferable communicator. Thus, account identifiers, accounting information, and security information need only be entered once or updated once. In contrast, a group of users without a transferable communicator may have to enter this information once per user, or once per mobile device, or once for each mobile device of each user.

The range of areas within which service is available is substantially increased by some embodiments of the invention. From the user's point of view, all services (both voice and data) are available whenever either a data communication link or a voice communication link is available.

One-time costs for mobile devices are substantially decreased by some embodiments of the invention because the components within such devices are reduced. Rather than having RF circuitry, a transmitter, a receiver, nonvolatile memory, and a baseband modem in each mobile device, these are shared across two or more mobile devices.

These savings may make it cost effective to add wireless capability to devices that otherwise would not have wireless capabilities, such as music players for example. Further, these savings may expand the market for wireless versions of devices whose sales volumes are sensitive to price, such personal digital assistants for example.

Further, one-time costs for mobile devices are substantially reduced in situations where a number of individuals can share one transferable communicator. For example, a family whose members only one need wireless access one at a time can share a single transferable communicator. Or a department that rarely has more than two employees traveling at the same time can share two transferable communicators.

Recurring costs for subscriptions for communication services are substantially decreased by some embodiments of the invention. A user need only purchase one service plan for the transferable communicator, not one for each of his several mobile devices, or one for each service on each device. Further, when both a GSM/CDMA communication link and an Ethernet communication link, for example, are available, the controller can select the less expensive link.

The quality of communication links with mobile devices is increased by some embodiments of the invention. For example when both a GSM link and an Ethernet link are available, the quality of service can be increased because the controller can select the better link. Alternatively, the user can specify in a preference setting stored in the nonvolatile memory whether the controller should select the better quality link or the less expensive link when more than one link is available.

Security and privacy are substantially increased by some embodiments of the invention. An important security issue for mobile devices and communication is authentication of users to prevent unauthorized access to information or services. The controller can require that the user enter the correct password to use the transferable communicator, thus preventing unauthorized users from gaining access to anything via the transferable communicator.

Further, the nonvolatile memory within the transferable communicator can store a substantial amount of security-related information, such as the serial numbers of computers, phones and PDAs with which this particular transferable communicator can be operated. The controller within the transferable communicator can refuse to initiate a communication link with an unauthorized mobile host device.

Further, the nonvolatile memory within a transferable communicator can store the private key of the user, which can be used, for example, to sign access requests. The system that grants such access requests can then use the public key of the user to authenticate that the access request came from the user (or at least from someone who knew the user's private key). Similarly, the nonvolatile memory can store the public keys of servers or individuals on the other end of the communication link, which can be used to verify that they are who they claim to be.

Another important security issue for mobile devices and communication to prevent both casual eavesdropping and systematic interception of the voice and data information that is conveyed over a communication link. The nonvolatile memory can store the encryption keys used to encrypt and decrypt communications. When public key encryption is used, the information communicated is very secure from interception and eavesdropping.

The invention can be exploited in industry, as will be obvious to one skilled in the art in light of the descriptions contained herein of the invention and of using the invention.

The invention can be made using manufacturing techniques that are known or described herein. The invention can be made from components and materials that are known or described herein. For example, transmitters and baseband modems are known components that are currently available from multiple manufacturers in the industry.

The invention solves immediate problems and meets immediate needs that are described herein. For example, many users of wireless communication devices have experienced inconveniences and have paid costs that would be reduced if they were to use the invention.

The scope of the invention is set forth by the following claims and their legal equivalents. The invention is subject to numerous modifications, variations, selections among alternatives, changes in form, and improvements, in light of the teachings herein, the techniques known to those skilled in the art, and advances in the art yet to be made. The figures and descriptions herein are intended to illustrate the invention by presenting specific details; they are not intended to be exhaustive or to limit the invention to the designs, forms and embodiments disclosed.

1. A wireless communicator (110) adapted for use with an active host (210), the wireless communicator comprising:
a voice receiver (260) configured to receive an incoming voice radio signal (264) and to provide based thereon an incoming voice baseband signal (262);
a voice transmitter (270) configured to receive an outgoing voice baseband signal (272) and to transmit based thereon an outgoing voice radio signal (274);
a data receiver (260) configured to receive an incoming data radio signal (264) and to provide based thereon an incoming data baseband signal (262);
a data transmitter (270) configured to receive an outgoing data baseband signal (272) and to transmit based thereon an outgoing data radio signal (274); and
a baseband modem (230) configured to receive the incoming voice baseband signal and the incoming data baseband signal, to produce the outgoing voice baseband signal and the outgoing data baseband signal, to receive an outgoing host signal (214) from the active host, and to provide an incoming host signal (212) to the active host;
wherein the wireless communicator is adapted to be transferred across and to operate with at least two mobile host devices of different types, where at any one time one of the mobile host devices is the active host.

2. The wireless communicator of claim 1, wherein:
the baseband modem is further configured to operate in a mode selected from a mode that converts the incoming voice baseband signal to the incoming host signal, a mode that converts the incoming voice baseband signal to the outgoing data baseband signal, a mode that converts the incoming data baseband signal to the incoming host signal, a mode that converts the incoming data baseband signal to the outgoing voice baseband signal, a mode that converts the outgoing host signal to the outgoing voice baseband signal, a mode that converts the outgoing host signal to outgoing data baseband signal, and a mode that is a combination of at least two thereof; and
the wireless communicator further comprises a controller (250) configured to control the mode of the baseband modem.

3. The wireless communicator of claim 1, further comprising:
a controller (250) configured to initiate a communication link between the wireless communicator and an external device, the communication link being selected from a voice communication link (190), a data communication link (192), and a low-power communication link (194).

4. The wireless communicator of claim 3, wherein:
the controller is further configured to determine which communication links are currently available, to select a one of the available links and to initiate the communication link on the preferred link.

5. The wireless communicator of claim 3, wherein:
the controller is further configured to keep the communication link active while the wireless communicator is transferred from a first mobile host device being active to a different mobile host device being active.

6. The wireless communicator of claim 3, further comprising:
a nonvolatile memory (255);
wherein the controller is further configured to use data held in the nonvolatile memory to initiate the communication link.

7. The wireless communicator of claim 6, wherein the data used by the controller is selected from subscription data, user identification data, user preference data, security data, and a combination of at least two thereof.

8. The wireless communicator of claim 1, wherein the incoming voice radio signal and the outgoing voice radio signal are selected from mobile telephone signals, advanced mobile phone system (AMPS) signals; global system for mobile communication (GSM) signals, time division multiple access (TDMA) signals, code division multiple access (CDMA) signals, and wideband code division multiple access (WCDMA) signals.

9. The wireless communicator of claim 1, wherein the incoming data radio signal and the outgoing data radio signal are selected from wireless local area network (WLAN) signals, wireless Ethernet signals, Institute of Electrical and Electronics Engineers (IEEE) standard 802.11 signals, low-power wireless signals, and Bluetooth signals.

10. The wireless communicator of claim 1, wherein the active mobile device is of a type selected from a mobile telephone (120), a personal digital assistant (130), a music player (170), a radio, a mobile computer (145), a notebook computer, a pocket computer, a tablet computer, and a device that is a combination of at least two thereof.

11. The wireless communicator of claim 1, further comprising:
a second data receiver (260) configured to receive a second incoming data radio signal and to provide to the baseband modem based thereon a second incoming data baseband signal;
a second data transmitter (270) configured to receive a second outgoing data baseband signal from the baseband modem and to transmit based thereon a second outgoing data radio signal; and
wherein the incoming data signal and the outgoing data signal are wireless local area network (WLAN) signals and the second incoming data signal and the second outgoing data signal are low-power wireless signals.

12. The wireless communicator of claim 1, wherein the baseband modem is further configured to provide to the voice transmitter data information that is formatted for transmission over a voice communication link (190), and to receive from the voice receiver data information that is formatted for transmission over the voice communication link.

13. The wireless communicator of claim 1, wherein the baseband modem is further configured to provide to the data transmitter voice information that is formatted for transmission over a data communication link (192), and to receive from the data receiver voice information that is formatted for transmission over the data communication link.

14. A wireless communicator adapted for use with an active host, the wireless communicator comprising:
means for receiving an incoming voice radio signal and for providing based thereon an incoming voice baseband signal;
means for receiving an outgoing voice baseband signal and for transmitting based thereon an outgoing voice radio signal;
means for receiving an incoming data radio signal and for providing based thereon an incoming data baseband signal;
means for receiving an outgoing data baseband signal and for transmitting based thereon an outgoing data radio signal; and
means for modulating the outgoing voice baseband signal and the outgoing data baseband signal, and for demodulating the incoming voice baseband signal and the incoming data baseband signal;
wherein the wireless communicator is adapted to be transferred across and to operate with at least two mobile host devices of different types, where at any one time one of the mobile host devices is the active host.

15. The wireless communicator of claim 14, wherein the means for modulating and demodulating is further means for converting the incoming voice baseband signal to an incoming host signal provided to the active host, for converting the incoming voice baseband signal to the outgoing data baseband signal, for converting the incoming data baseband signal to the incoming host signal, for converting the incoming data baseband signal to the outgoing voice baseband signal, for converting an outgoing host signal received from the active host to the outgoing voice baseband signal, and for converting the outgoing host signal to outgoing data baseband signal.

16. The wireless communicator of claim 14, further comprising:
means for controlling a communication link between the wireless communicator and an external device, the communication link being selected from a voice communication link, a data communication link, and a low-power communication link.

17. The wireless communicator of claim 14, wherein the means for modulating and demodulating is further means for converting data information into the outgoing voice baseband signal and for covering the incoming voice baseband signal into data information, whereby data is sent over a voice communication link.

18. The wireless communicator of claim 14, wherein the means for modulating and demodulating is further means for converting voice information into the outgoing data baseband signal and for covering the incoming data baseband signal into voice information, whereby voice is sent over a data communication link.
